(19) United States
(12) Patent Application Publication
(10) Pub. No.: US 2006/0235885 A1
(43) Pub. Date: Oct. 19, 2006

(54) Selective delivery of digitally encoded news content

(75) Inventors: Jay D. Steele, Nova Scotia (CA); Matthew W. Houser, Ontario (CA)

Correspondence Address: Allan W. Watts;Bryan Cave LLP, Suite 2200, Two North Central Avenue, Phoenix, AZ, 85004-4406, US

(73) Assignee: Virtual Reach, Inc.

(21) Appl. No.: 11/109,042

(22) Filed: Apr. 18, 2005

(51) Int. Cl. G06F 7/00; G06F 17/00

(52) U.S. Cl. 707/104.1

(57) ABSTRACT

News content is received from news feeds, sorted by content, and distributed to user nodes so that each user receives a custom compilation of news articles. This involves receiving to a news communication subscription system a plurality of news articles, each news article comprising digitally encoded news content, from at least one news feed, selecting and storing at least one of the news articles according to pre-determined system selection criteria, analyzing the news content of the at least one news article according to acquisition metrics associated with a pre-determined node, determining whether the news article meets a pre-determined threshold, preparing a news communication comprising the at least one news article, and sending the news communication to the pre-determined node.

### FIELD OF THE INVENTION

This invention is directed to the delivery and distribution of news content through computer communications systems.

### BACKGROUND OF THE INVENTION

In recent years there has been a rapid increase in the production and adoption of mobile data communications devices and services in the worldwide marketplace. Wireless networks and operational capabilities potentially allow users to carry the devices almost anywhere and to use them to store electronic data. With the ability to employ data protocols such as HTTP (for Internet), POP/IMAP (for mail) and GSM (voice), these devices have significant communications versatility. These devices typically have user input components, for instance, phone keypads and joysticks. Some have full keyboards, which enhance their communications capability.

These devices may employ specific wireless capabilities and subscribe to wireless services to improve their functionality and efficiency, including using proprietary data transports to link the device to a land-based server. Of the various wireless services, some allow data to be sent, or pushed, to a mobile device from a land-based server with or without any initiating request from the mobile device. Because these devices are typically accessible using standard Internet protocols, they are capable of communicating and interacting with most of the standard technologies and services in use with personal computers such as the various Microsoft Windows operating systems or Apple Mac OS X operating systems, and their various associated functions and applications.

Within this environment, technologies such as the HTTP (Hypertext Transfer Protocol), HTML (Hypertext Markup Language) and XML (eXtensible Markup Language) standardize the way devices and people communicate. For instance, XML is quickly becoming the foundation for allowing computer-based services to communicate with each other. One form of XML called RSS (Really Simple Syndication) allows news articles to be published in a standard format. Presently, RSS-based news articles are widely available on the Internet, used by everything from personal web logs to commercial news agencies. In addition to RSS, other competing news syndication formats also exist, including Atom.

RSS communicates news articles in a digitized data format through data feeds in machine readable formats to be read and processed by receiving devices, which may be computers or other programmable nodes, which then format the news articles to be read by users. Applications such as RSS Readers or RSS Aggregators have been developed for most popular computing platforms (such as Microsoft Windows and Mac OS X) operating the receiving devices. These applications allow users to subscribe to RSS data feeds, poll the feeds to see when new articles are available, and present the feeds in a user readable format. Typically, dedicated applications for reading news data feeds poll feeds at regular intervals (once an hour, for example) to retrieve available news articles and their updates. Web-based RSS aggregators read RSS data feeds and present the articles in a readable HTML format within a web browser.

With respect to receiving news data feeds, and presenting these in a user readable format, mobile data communication devices have limitations that differentiate them from personal computers. These include limitations on the amount of memory, the speed of the central processing unit, the physical size of the display, the physical size of the input devices, the speed and cost of network communication, and the power source and battery life, among others. As such, the rise in popularity of RSS technology has exposed a number of shortfalls in its application to and communications with mobile devices. These shortfalls include:
1. Low Bandwidth and Wireless Network Data feeds: News readers often require the application to periodically poll a collection of remote servers to see if new news articles are available for delivery. Unfortunately, a wireless network may be bandwidth constrained and may be highly latent. Wireless services operating such networks often compensate for these limitations by imposing charges on users whenever data is sent or requested. Thus, polling for new content can add costs on to the subscription or service charges for a user, even if there are no updated news articles to receive. As can be imagined, where the polling rate is set to a frequent interval (once per minute, for example), these costs can mount quickly.
2. Multiple Source Connection Latency: A typical subscriber to an RSS based service may have access to many news channels, with each news channel periodically publishing a few new articles. In traditional usage of RSS technology, a separate network connection must be established to each separate news feed to pull one or two new articles from each. Network connections in wireless tend to have high latency, and establishing connections to servers can be time-consuming. Establishing new connections to each RSS based news feed can multiply the time delays.
3. Redundant data transmission: In general, a complete RSS based news feed will be stored in a single XML file. This means that the entire RSS based news feed must be transmitted over-the-air (with the user incurring additional charges for the data received) to the device so that the device-side application can then decide to discard articles that have already been previously downloaded. This constant and repetitive downloading of data can be wasteful.
4. Information duplication: Many RSS news articles are similar or even identical. If a user is subscribed to two different news feeds that are publishing the same article (which may even be syndicated from the same source), the user may have to store and pay for two separate data charges to receive Identical articles.
5. Unwanted content: Often a user wants to receive news articles only concerning specific pre-determined topics. Yet RSS based news feeds often have no built-in facilities for personalizing delivery of news articles or news content.
6. Locating RSS based feeds:: RSS based news feeds that contain topics of interest are difficult to find (e.g. required browsing the wireless web, copying URLs, pasting them in other applications). This is a frustrating experience and is time consuming for a user, and may impose data charges for browsing. Although directories for RSS based news feeds exist, coordinating delivery of news articles from multiple directories may be difficult for a mobile user to efficiently accomplish and places a greater burden on the mobile device, its memory and its applications, including, for instance, the RSS reader/aggregator program(s) used.

Given the above, there is need for a system for aggregating, maintaining and serving news content by identifying the user requesting the data which addressed the above problems by:
1. Identifying when new news articles are available for a user, and notifying the user that the news articles have arrived (or on some systems, simply pushing the new news articles directly to the user);
2. Aggregating multiple source channels into a single news channel transaction with the user client, avoiding the need for multiple network connections;
3. Tracking which news articles a user has received in the past, and not sending the exact same articles to them over and over again;
4. Identifying whether two or more stories appear on the same topic, and suppressing the resending of similar data;
5. Allowing a user to identify content they are not interested in receiving, for instance, by setting pre-determined filtering criteria; and
6. Creating subscription preferences and parameters, for instance, by introducing relevant keywords and matching criteria to customize a news channel as a source of news articles sent to a user.

Other needs and potential for improvement may be apparent from this document, and different embodiments of this invention may partially or completely address one or more of these needs.

### BRIEF DESCRIPTION OF THE DRAWINGS

FIG. 1 is a system block diagram illustrating a communications and news article delivery network according to one embodiment of the invention.

FIG. 2 is a system block diagram illustrating the elements and functions used by a mobile terminal according to a particular embodiment of the invention.

FIG. 3 is a system block diagram illustrating the elements and functions of a news processing server according to one embodiment of the invention.

FIG. 4 is a flow chart illustrating an example of a method of selecting and delivering news articles performed according to an embodiment of the invention.

FIG. 5 is a flow chart illustrating an example of a method for personalizing of news content using filters according to a particular embodiment of the invention.

FIG. 6 is a flow chart illustrating an example of a method for personalizing of news content using keywords according to one embodiment of the invention.

FIG. 7 is a flow chart illustrating an example of a method for applying a hash key algorithm according to an embodiment of the invention.

FIG. 8 is a flow chart illustrating an example of a method of applying a redundancy algorithm according to an embodiment of the invention.

FIG. 9 is a flow chart illustrating an example of a method of assembling news articles in a news communication according to one embodiment of the invention. And,

FIG. 10 is a flow chart illustrating an example of a method of news article delivery to a mobile terminal with either data-push or e-mail capabilities according to an embodiment of the invention.

### SUMMARY OF PARTICULAR EMBODIMENTS OF THE INVENTION

In general, the method and system of the present invention may be conducted over a digital communications connection or network, for instance, the Internet, using a node having a graphical user interface (GUI) for the entry and receipt of news articles by a user, and to input preferences, selection criteria and prompts to receive news articles.

Various embodiments of the invention encompass a method of receiving news content from at least one of a plurality of news feeds at a pre-determined node. This may involve receiving to a news communication subscription system a plurality of news articles from at least one news feed, wherein each news article contains digitally encoded news content. Such a method may also include the steps of selecting and storing at least one of the news articles according to pre-determined system selection criteria, and analyzing the news content of the news article according to acquisition metrics associated with a pre-determined node. In some embodiments, the analysis of news content determines whether the news article meets a pre-determined threshold. Certain embodiments may also include preparing a news communication containing the news article, and sending the news communication to the pre-determined node for display on a graphical user interface to the user.

Some embodiments of the invention also include a system for news article delivery that includes a server in communication with a plurality of news feeds for receiving news over a communication network. Certain embodiments may include a news channel parser in communication with the server to read the news feeds for available news articles, a news article analyzer in communication with the news channel parser to analyze the news articles and to assign to each news article a content metric, or a combination thereof. Some embodiments of the invention may have a news channel database in communication with the news article analyzer to store news articles according to their content metric. Various embodiments may include a news channel processor in communication with the news channel database to assemble stored news articles into a customized news channel. In some embodiments, the customized news channel assembly of news articles is based on a comparison of acquisition metrics associated with a local node to the news article content metric, for delivery to the user at a local node. Certain embodiments include a news article push module in communication with the news channel processor for delivering the news channel to the local node, a local node in communication with the news article push module, or a combination thereof. The local node may be in communication with a graphical user interface.

In some embodiments, the invention encompasses hardware, for instance a server or grouping of servers, wherein the server encodes automated instructions in a machine readable format. The server may include a news channel parser to read the news feeds for available news articles, a news article analyzer in communication with the news channel parser to analyze the news articles and to assign to each news article a content metric, or both. In some embodiments, a news channel database is in communication with the news article analyzer to store news articles according to their content metric. In particular embodiments, a news channel processor may be in communication with the news channel database to assemble stored news articles into a customized news channel, and the customized news channel may be based on comparison of predetermined news article selection criteria to the content metric, for delivery to a user at a local node.

Various embodiments of the invention provide as an object or benefit that they partially or fully address one or more of the needs or potential for improvement described herein, for instance, in the background section above. The present invention provides various embodiments of systems and methods that may be accurate, convenient to use, and reliable for facilitating the customization and regularization of news content delivery and the display of news articles to a user and/or subscriber. Further features and advantages of the invention may be apparent to those skilled in the art.

### DETAILED DESCRIPTION OF EXAMPLES OF THE INVENTION

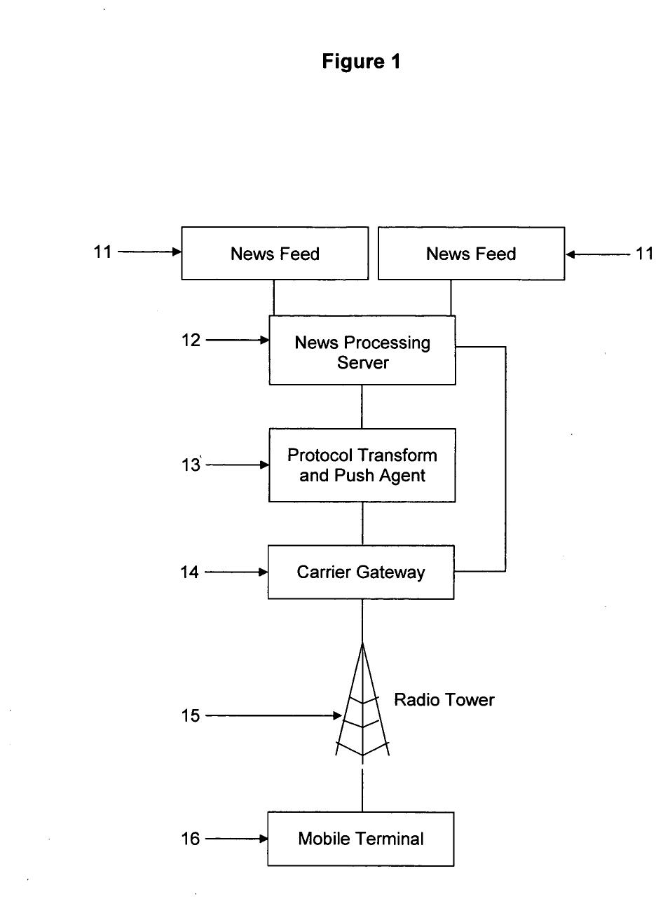

FIGS. 1-3 are system block diagrams illustrating some examples of particular embodiments of the invention. The blocks correspond to components of the system depicted. Groupings of system elements and their corresponding functions are shown, along with communication between elements as indicated by connecting lines. Referencing these elements and groupings by the names given is for purposes of convenience, and the drawings merely show one manner of grouping the various elements and functions of particular embodiments of the invention. In different specific embodiments, various groupings of elements and functions and various connections may be used. In different embodiments, the elements and their functions may reside in a single computer system or multiple computer systems or be otherwise organized within a system or systems and may be close to or remote from one another. Moreover, the functions described herein may be in addition to other functions of the system or systems not described herein, or in some embodiments, the functions described herein may be exclusive of other functions.

Each identification herein of particular components or functions performed by the system for doing something or of steps performed in the course of carrying out a method may refer to or encompass a number of possible embodiments, structures, and steps for performing the function(s), including various possible architecture and programming formats. These functions and their communication and/or connections may be provided and performed through the use of various components, computers, computer networks, and other elements and techniques, including hardware, firmware, software, databases, modules, routines, programs, algorithms, engines, plug-ins, or other structures within a computer or system that may be used to provide and/or perform the particular function(s) identified. While the system and its groupings of functions and operations are unique and novel, coding, devising these structures and devising their architecture are a matter of design choice within the ordinary skill of the art. Moreover, combining or separating one or more functions in or between various components, computers, systems, programs, or program subunits may be accomplished by methods and connectivity protocol and/or devices, e.g., signaling, cabling and/or other electrical data connections, known in the art.

Therefore, the functions identified herein (e.g., in the figures) as within the components of various examples of the system may also be independent of the particular components identified and may be interrelated and/or accessible to the user through various interconnections or otherwise networked in ways known to the art. Each of the functions and components may be close to or remote from one another, either geographically or within a host structure. As noted above, the consolidation of the various functions of the system into the components identified herein is to illustrate the functions and their cooperation and interaction and does not and should not be understood to limit the location of these functions to being within particular components or to limit the location of these components to being within particular structures.

Various embodiments of the invention entail systems and methods applicable to the operations of a mobile data communication device or mobile terminal which may be a personal data assistant, or other digital communications or computing device that is readily carried or transported to accompany a user. In general, this may involve a user subscribing to a set of criteria, which may include a specific news URL, matching text keywords, dates and authors to which they wish to be alerted when news articles containing those keywords appear on a collection of arbitrary or specific news feeds, or a combination thereof. In various embodiments, this subscription may be sent to a news aggregation subscription server, which may monitor a collection of news feeds for matches to the specified subscription criteria. In some embodiments, when a new news article matching the specified criteria is detected that contains content that the user has not seen before, the server sends either the contents of the new article (using a data-push mechanism) or a notification that new content is available to the mobile data communication device that has subscribed to that set of criteria.

As used herein, a “user” is not restricted in its application to a person but may also refer to an automated tool for the entry and receipt of information over a communications link. This link may be a data link and the automated tool may be a local computer system, network or node used by any party interested in receiving and displaying news content. The system or method of the invention may be controlled, managed, implemented or administered as part of or as an entire subscription based system for the dissemination of news content to subscribers having access to at least a portion of the system and optionally including software, programs, functions, systems or devices on a local node to assist in receiving and displaying news content.

Further, as used herein, “news”, as used in the context of “news content”; “news channel”; “news feed”; and “news article”, as examples, is meant to broadly reference informational content that is of interest to human readers and which may comprise textual, graphical, literary, illustrative or other works of authorship, compilations or portions thereof, without limitation as to language, script or characters, which may be displayed to a viewer at a node on a graphical user interface, e.g., a monitor, associated therewith.

Turning now to the figures, some examples of embodiments of the invention will be described in detail. FIG. 1 is a systems block diagram illustrating one example of an embodiment of a system according to the invention. In the embodiment illustrated, news feeds 11 provide data communications, and may be sources for news articles, which may be publicly available on the Internet, for instance. News feeds 11 may use a variety of formats, including but not limited to: RSS (such as RSS 0.91, 0.92, 0.93, 0.94, 1.0 and 2.0) and Atom. News feeds 11 may be stored in a document (in a format such as XML), or generated on the fly, for instance, by a web server.

In the embodiment illustrated, news processing server 12 processes news feeds 11 to create user-specific compilations of news articles for subscribers of the system. In some embodiments, the system may also include protocol transform and push agent 13 to convert Internet transports and protocols (such as TCP/IP and HTTP) into specific wireless protocols (such as WAP or other proprietary protocols like BlackBerry®) and in some embodiments may encrypt data for secure over-the-air transmission. Particular embodiments may also be capable of pushing content directly to a remote node, for instance, to mobile terminal 16, with or without the user or a remote node requesting it. In the embodiment illustrated, carrier gateway 14 codes and encodes information to and from protocols delivered from the protocol transform and push agent 13 to mobile terminal 16 using, for instance, over-the-air data transport system 15, which may be such systems as GPRS/GSM and CDMA, or other transport known in the art. In some embodiments, there is no push agent. In particular embodiments, the protocol transform is part of the carrier gateway. Various transforms and protocols may be used in different embodiments to transport news feed information.

A node, such as terminal 16, may be, for example, a mobile terminal in communication, remotely, wirelessly, or both, with a computerized communications network, such as the Internet. As used herein, “node” also encompasses other computer devices such as a personal computer, laptop computer, personal data assistant, electronic messaging terminal or other apparatus for sending and receiving information over a communications network. In particular embodiments, terminal 16 contains a dedicated mobile application for presenting news feed information to users and allowing them to manage news feed subscription information.

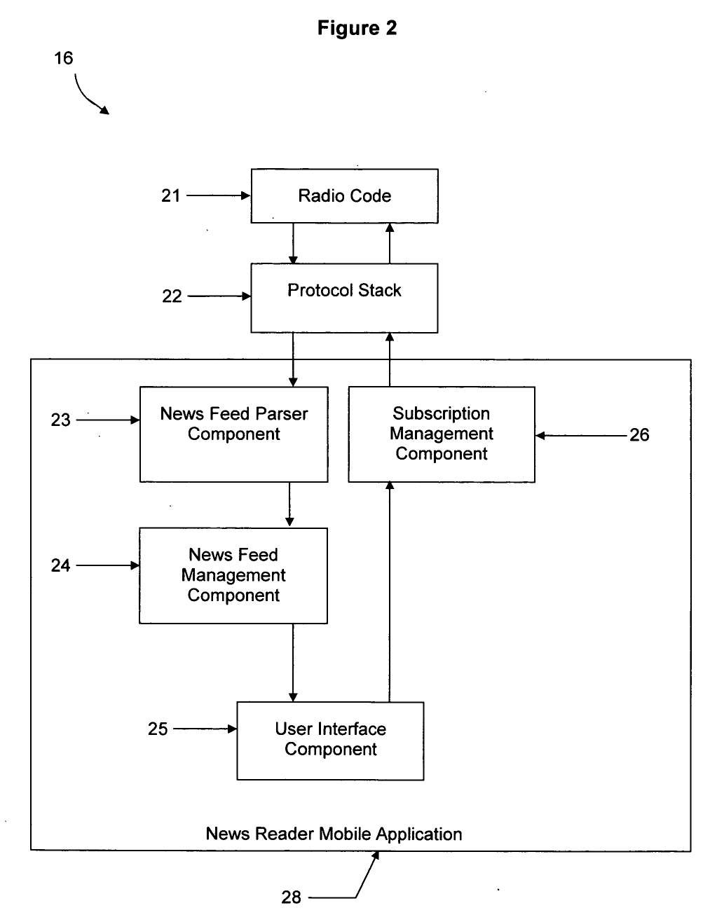

FIG. 2 illustrates a particular embodiment of mobile terminal 16 depicting, among other things, the operation, internal functions, and architecture of this embodiment. In the embodiment illustrated, radio code 21 communicates, for example, via over-the-air data transports such as GPRS/GSM or CDMA. In some embodiments, protocol stack 22 converts data received from radio code 21 into protocols and transports used by device applications, such as, but not limited to, TCP/IP, HTTP, WAP, HTML and XML, and provides the data to news reader mobile application 28 in this particular embodiment.

Several components of news reader mobile application 28 are shown, depicting a particular embodiment. In some embodiments, news feed parser 23 takes XML data formatted as a news feed (e.g. RSS or Atom based) and builds data structures usable by the news reader mobile application 28. In particular embodiments, news feed manager 24 stores and interprets those news data structures and makes decisions on what to present to the users, in what order, or both, and may provide other features to make management of the news feed data efficient and useful for the user. User interface 25 may be used to render news headlines and stories to the end-user. In the embodiment illustrated, subscription manager 26 communicates news feed subscription and customization information, for instance, back through the protocol stack 22, to news processing server 12 which may customize news feed transactions back to the user.

As used herein, “communicate,” “communicating” or “in communication with,” when applied to functionalities or components of the system, involve various cooperation, transmission, forwarding, relay or other means of associating the various functionalities or components of the system, or of associating the user and input received from the user with the various functionalities or components of the system, with respect to information or data they act upon.

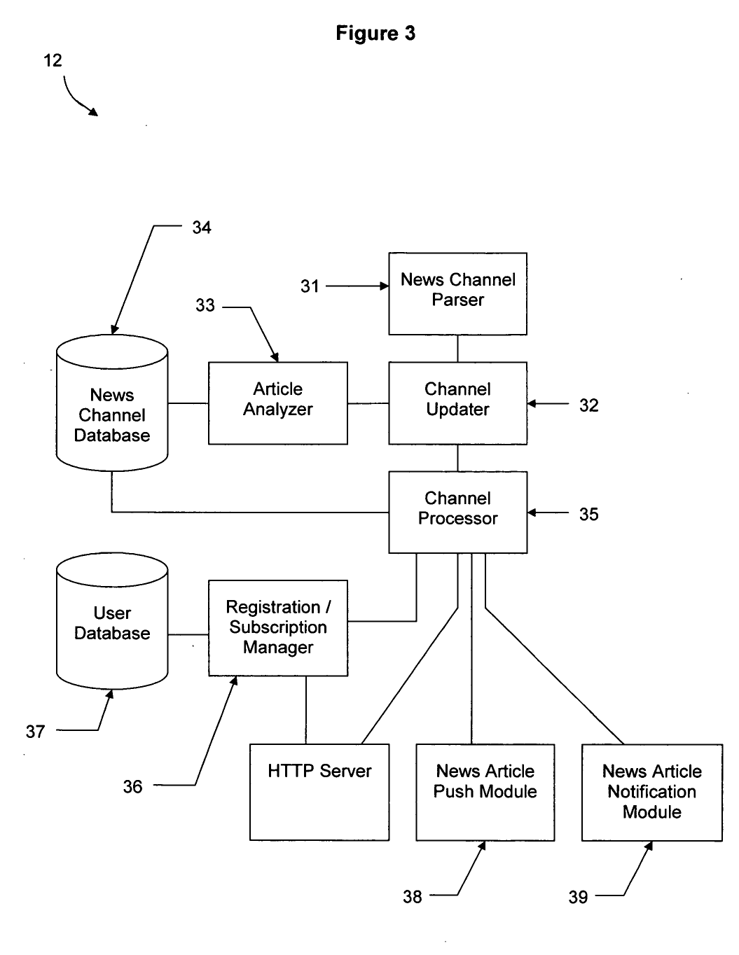

FIG. 3 is a systems diagram illustrating operations and architecture of particular examples of news processing server 12 and Protocol Transform and Push Agent 13 of the embodiment illustrated in FIG. 1. FIG. 3 illustrates one type of architecture and/or data pathway for a particular system. The system illustrated may receive, process, and store news articles from one or more news channels, which may include news feeds 11, for example. Such a news channel may be the source of news articles for a user-customized compilation of news articles that is created, administered and maintained by the system, as will be further described. It is to be understood that a system or server 12 may also comprise other system news channels, for instance, that link to and receive articles into a central news channel database.

In the embodiment illustrated, news channel parser 31 reads news feeds from a variety of sources, for instance, those available on the Internet, to receive news articles from the news feeds 11, for example. In some embodiments, news channel parser 31 may be configured to parsing various flavors of RSS (for example, 0.97-2.0), Axom, and other kinds of news syndication format. In the example illustrated, channel updater 32 may periodically reconnect to the news feeds 11 to update news feed information, which may include determining the availability of new news articles. In this embodiment, article analyzer 33 may analyze the incoming news articles and assign context information to the article (such as a keyword bit mask representing the important words in the article), which may be done prior to storage. News channel database 34, in the embodiment illustrated, stores news articles and system news channel data, e.g., which may include pre-determined criteria for receiving and/or selecting news articles, into the system news channel.

In particular embodiments, channel processor 35 may be notified by the channel updater 32 when new news articles are available for processing, and may assemble the articles into a customized news channel designed for specific users according to their news customization preferences. In some embodiments, channel processor 35 obtains information on how to assemble customized news channels from articles stored in news channel database 34 based on, for instance, comparison of news article content information assigned by article analyzer 33 with pre-determined user preferences, other information, or a combination thereof, which in some embodiments may be stored elsewhere.

Registration/subscription manager 36 my listen for connections from the mobile terminal regarding user or subscription preferences (via subscription management component 26), and may store these, for instance, at a user database 37. In particular embodiments, user database 37 stores preferences received and other information about each user and/or their subscription, including, for example, unique identification codes of user nodes and user-agents authorized to obtain news information from the articles they have downloaded in the past. In some embodiments, user database 37, may include information regarding which news feeds users wish to obtain news from, any filters that they wish to use to personalize what specific news articles they receive, or a combination thereof.

In some embodiments, news article push module 38 can be used where the mobile terminal supports a data push mechanism, such as a BlackBerry® system, for example. Push module 38 may be notified by channel processor 35 when new news articles are available for a specific user, and then may push those new articles to mobile terminal 16. Specifically, news articles may be pushed to an application at mobile terminal 16 designed to read the news, which may compile or group one or more news articles within a news communication, i.e. the message, link(s) or messaging format received by the user at the mobile terminal. News article notification module 39 may be used for embodiments where mobile terminal 16 supports a messaging mechanism such as email or SMS, but might not support particular embodiments of the push model of data transmission. In particular embodiments of the invention, news article notification module 39 is notified by channel processor 35 when new news articles are available for a user. Channel Processor 35 may then send a message to mobile terminal 16, for example. This message may be received and processed by mobile terminal 16, which then may initiate a request, for example, from the news reader mobile application 26, to receive updated news articles. In some embodiments, server 12 listens for requests from mobile terminal 16 which may be, for example, requests to receive updated news information, or instructions to update subscription preference information. Note that Server 12 may use HTTP or a different protocol, such as FTP or another proprietary protocol.

In one operational example, a user owns a mobile terminal 16 that supports a data push mechanism. The user has a news reader mobile application 28 and has subscribed to a number of news channels by entering them into the news reader application 28. In this example, the news reader application 28 contacts news processing server 12 (using, for example, an HTTP connection), which receives and stores the new subscription information for that user in, for instance, at user database 37, and adds the subscribed channels to the channel database 34. For embodiments where the mobile terminal 16 is a BlackBerry® device, for instance, running an RSS reader application, the BlackBerry® may communicate over a GSM network using the GPRS data communication protocol to a wireless service provider. The wireless service provider may decode the GPRS data and route it to the news processing server 12, which, in particular embodiments, operates on a system of Microsoft® Windows NET Servers on Intel Pentium®-class (or compatible) processors, with sufficient CPU, bus and memory processing power to accommodate the number of users on the system. In particular embodiments, news processing server 12 communicates via Internet broadband services with a number of RSS servers, each running various operating systems on various hardware configurations (for example, a Linux-based machine running on a PowerPC architecture).

Particular embodiments of the invention also encompass selective assembly of news articles in a customized news channel created in whole or in part by a user. A user can create a customized news channel by indicating, for example, they would like to receive any news containing the keywords ‘Washington’ and ‘Politics’ from all available news feeds 11. The user also can create a filter, indicating that they do not want to receive any articles containing particular key words, such as ‘Hollywood’, for example.

In some embodiments, the system implements a method for assembling customized news channels utilizing the various system functions, components and elements depicted in FIGS. 1-3, although other implementations, deployments and architecture to apply the method may be used instead. For ease of reference, and not for purposes of limitation, the description of some examples of methods of the invention may reference components using their designations from FIGS. 1-3.

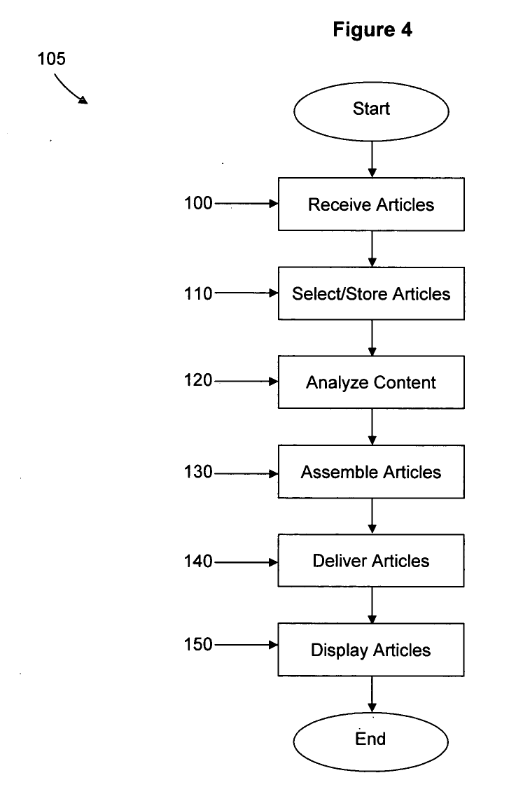

Method 105 illustrated in FIG. 4 encompasses a series of manipulative steps which may be carried out by a system in accordance with the invention, and may use information provided by the user as to news content preferences. These preferences may be used in selection and filtering of news articles. Customized news channels may be formed which are assemblies of multiple news articles for delivery to the user at, for instance, the user's mobile terminal 16, where the articles may be displayed on an associated graphical user interface 25.

In some embodiments, method 105 includes receiving news content from at least one of a plurality of news feeds 11 at a pre-determined node, for instance a user's mobile terminal 16. With reference to FIG. 4, in the embodiment illustrated, a plurality of news articles are received (step 100), for example, by a news communication subscription system. These news articies may comprise digitally encoded news content from at least one news feed 11. The articles may be received as a result of a search and update conducted by the system at repeated intervals, which may be asynchronous intervals, e.g., upon detecting that a new news article became available. At least one of the news articles may be selected and stored (step 110), for instance, by the news channel parser 31, according to pre-determined system selection criteria. This criteria may be a function of the availability and timeliness of the news article, or other metrics that may be set by the system with respect to news feed parsing. In some embodiments, the news article selected is assigned a content metric which may be a bit hash key derived from analysis of textual data in the news article. In some embodiments, the bit hash key may be derived after the textual data is first processed to remove common keywords.

The system may analyze the news content of the news article (step 120), for instance at the news channel processor 35. Analysis of news content may determine whether the news article meets a pre-determined threshold. If so, news channel processor 35 may assemble the news article into a customized news channel and may prepare a news communication to send the article, and any other assembled articles, to a user's mobile terminal 16. The pre-determined threshold may be based on an acquisition metric associated with the user and/or his mobile terminal 16 or other user node. Acquisition metrics may reflect user preferences, redundancy safeguards, determining if a user's subscription account is active, or a combination thereof. Each such acquisition metric may encompass a number of operations. For instance, an acquisition metric may operate as a filter that selectively admits or excludes news articles, e.g., resulting from a user input indicating, for example, that they do not want to receive any articles containing ‘Hollywood’, or indicating they would like to receive any news containing the keywords ‘Washington’ and ‘Politics’ from all available news feeds. In each instance, the system, and for instance, the channel processor 35, may determine matching keywords in one or more news article, using the content metric assigned to the news article, to determine whether to select the article for assembly into a customized news feed, or to ignore a matching article, as the case may be. Consequently, keyword relevancy values based on the news content analysis done by the article analyzer 33, for instance, may also be used to determine whether to select an article for delivery to a user.

The system in some embodiments also determines redundancy between news articles in one or more news communications based on news articles already delivered to the user, for example, at mobile terminal 16. Thus, the content acquisition metric may operate a filter based on the news communications previously sent to the user and/or their mobile terminal 16 or node. As such, the acquisition metrics may be revised based on the news content of news articles assembled within a customized news channel and sent as one or more news communications to a user.

After application of one or more content acquisition metric, news articles meeting the thresholds may be assembled (step 130), for example, within a customized news channel, and then may be delivered (step 140), for instance, to a user's mobile terminal 16, either individually or as a grouping of articles in a news communication. Such a news communication, comprising one or more news articles, may be received on the user's mobile terminal 16, and the news articles may be displayed (step 150), for example, on the associated graphical user interface 25 for the user to view or read.

It is to be understood, that the system disclosed may be applicable to multiple news feeds 11 from multiple sources and so may be configured to aggregate, combine, or otherwise assimilate a plurality of news articles from a plurality of news sources and news feeds 11. The news articles may be accumulated and stored using assigned content metrics and then may be processed according to use content metrics from a system storage location, thus streamlining news article analysis (step 120) and delivery (step 150) to an extent unprecedented, while avoiding content redundancy and transmission and delivery costs associated therewith.

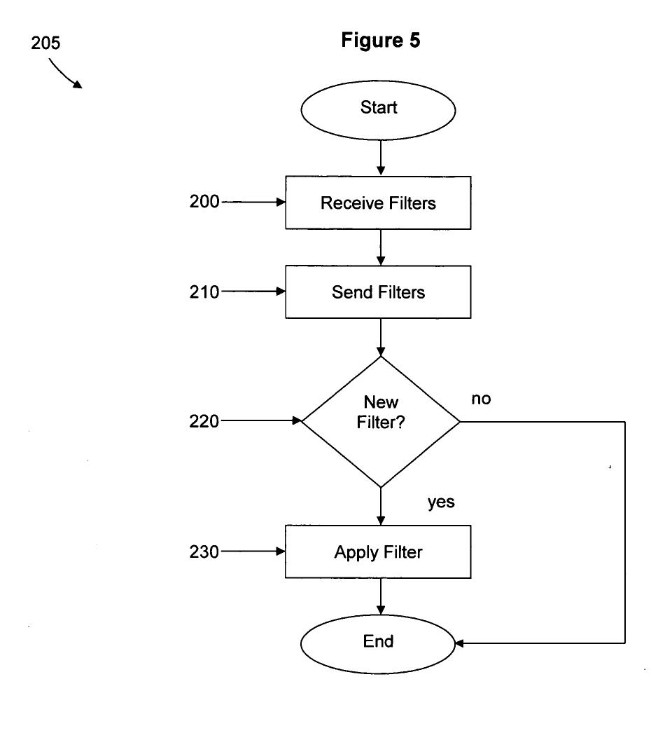

In particular embodiments of the invention, personalizing of news content using filters may be accomplished through method 205 illustrated in FIG. 5. A collection of filters may be received (step 200), for instance, from user inputs into a suitable GUI on mobile terminal 16. The collection of filters may be what the user wishes to apply to their news subscription. For example, they may wish to remove any articles older than 2 weeks, and remove any articles containing the keyword “Hollywood”. In some embodiments, the filters are received by a subscription manager 26 on the mobile terminal 16 which then sends these filters (step 210), for example, to registration/subscription manager 36 of the news processing server 12.

In some embodiments, news processing server 12 may evaluate whether new filters are being provided (decision step 220). In one such embodiment, when news content is being processed for a particular user, the channel processor 35 queries the registration/subscription manager 36 for any news filtering criteria. If any news filtering criteria is supplied by the registration/subscription manager 36, channel processor 35 applies the filters (step 230) to modify the content that is about to be sent to the user. For example, channel processor 35 may remove articles that match particular criteria in the filters.

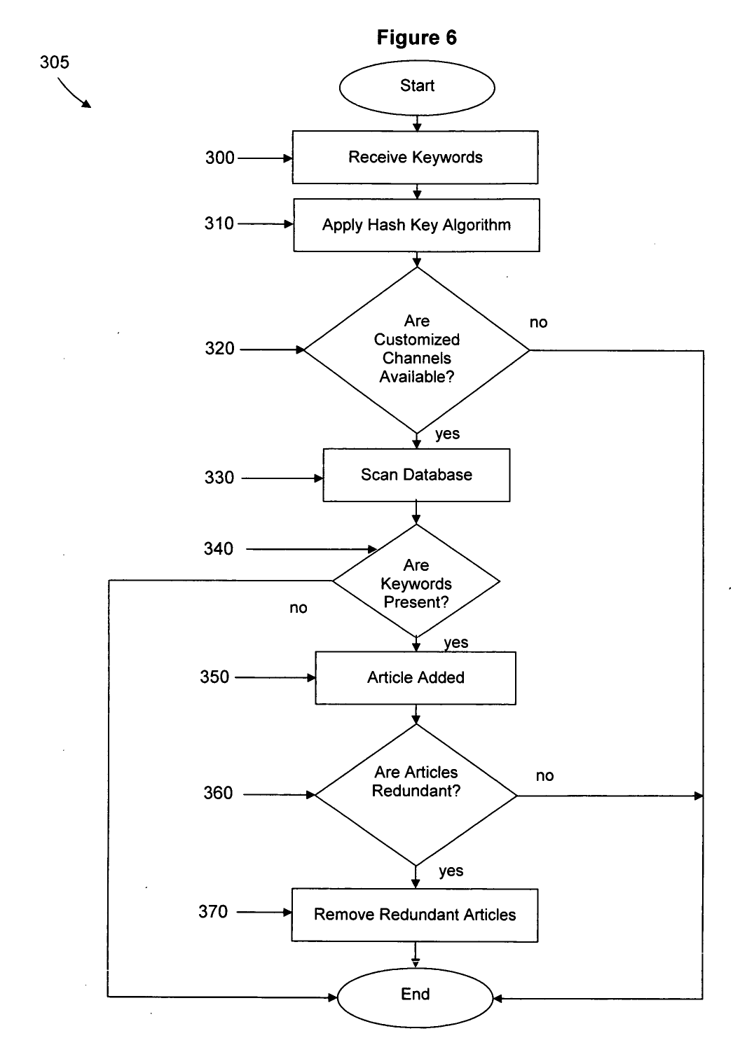

Personalizing news content by requesting content that matches specific criteria may be accomplished by the user in various embodiments of the invention by designating keywords as per method 305 depicted in FIG. 6. In some embodiments, the user enters keywords that comprise a description of content they wish to generate news articles from using subscription management component 26 on mobile terminal 16. The subscription management component 26 on mobile terminal 16 may then send the description so that the description or key words are received (step 300), for example, by registration/subscription manager 36 of news processing server 12. In a wireless system, the description may be sent over-the-air. In some embodiments, when the registration/subscription manager 36 receives the description (which may be a set of keywords) (step 300) it applies a hash key algorithm to the list of keywords (step 310) and, in some embodiments, may store the resulting hash key in the user database 37.

In some embodiments, channel processor 35 of news processing server 12 may query the registration/subscription manager 36, and method 305 may include the step of deciding if there are customized channels available (step 320), for example, for a particular user. If there are customized channels available, the channel processor 35 may scan its database (step 330) of available articles, for example, news channel database 34, for instance, by comparing hash keys. In such an embodiment, if the bits in the stored hash key match bits in an article's hash key (for instance, calculated when the article arrived in the article analyzer), those articles may be considered as candidates for addition to a news communication to be sent to the user. In some embodiments, the article may be checked again to see if it contains each keyword (step 340). This may eliminate the possibility that articles are identified due to random hash key bit collisions.

In certain embodiments, when an article is confirmed as meeting all content criteria (e.g., in steps 330 and 340), it then is placed in the user's news communication (step 350), for instance, by the channel processor 35. In some embodiments, at this point, each article may be checked for redundancy (step 360), for example, in case similar or identical articles have previously been delivered to the user. In particular embodiments, if an article is found redundant (step 360), it may be removed (step 370) from the users news feed transaction (or in some embodiments, not placed in the transaction in the first place). In certain embodiments, steps 310 to 370 of method 305 may be substituted for steps 110 to 130 of method 105 described above.

In particular embodiments of the invention, on the server side and independent of any user criteria, keywords, or filters, channel updater 32 may go through some or all of the news channels in the channel database that need updating, and parse them with news channel parser 31. As it reads the news channels, news processing server 12 may discard articles that have previously been loaded into the system. When it encounters new articles, news processing server 12 may deposit them in the channel database 34.

In one embodiment, when a new news article is received by channel database 34, article analyzer 33 looks at the article and records its hash keys using a hash key algorithm and stores the hash keys along with the article. In some embodiments, channel updater 32 then notifies channel processor 35 that new articles are ready for processing. Channel processor 35 may use the hash keys generated by the hash key algorithm to determine whether a news article possesses the desired news content in order to be routed to the user.

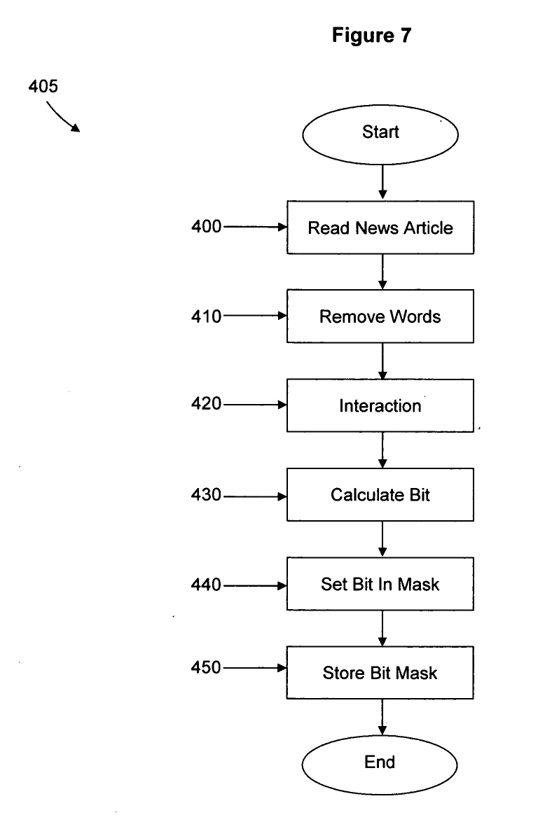

Method 405, as depicted in FIG. 7, is an example of a method of applying a hash key algorithm in accordance with the invention, which includes generating hash keys for a news article. Note that before method 405 begins, the size of the hash key (the number of bits) may have been pre-determined, for instance, where fewer bits means more bit collisions and a higher chance that two dissimilar articles will be marked as similar, but will also require less storage and will generally run faster. In the embodiment illustrated, a news article is read (step 400), for example, from a news feed 11 into memory. In some embodiments, irrelevant words are removed (step 410), for example, from the in-memory article. For instance, pronouns, certain adjectives and adverbs: e.g. “a”, “the”, “and”, “or” may be removed (step 410). In some embodiments, iteration over all remaining words in the in-memory article is performed (step 420), which may include marking a bit in the bit mask for each word. These steps may be performed in a different order in some embodiments. The bit to mask may then be calculated (step 430), for example, with a keyword bit determination algorithm involving setting the bit in the bit mask (step 440) and repeating until all of the words in the article (e.g., that have not been pre-filtered) have been processed. Some embodiments of method 405 also include storing the resulting bit mask (step 450), for instance, in a database associated with this article, for instance, in news channel database 34.

Note that this is only one example of a suitable algorithm, and one embodiment of the invention. A similar result can be obtained by not pre-filtering irrelevant words, but instead iterating over each word in the article and simply not processing words that meet the irrelevancy criteria. In some embodiments, the index of a bit in a bit mask is obtained for each keyword in an article. A bit index can be calculated using an algorithm, one that, for instance, sums unicode values of each character, divides that final sum by the number of bits in the bit mask, and obtains the remainder, e.g., the modulo, which may be the bit index for that keyword. Other methods in accordance with the invention may also yield satisfactory results. For instance, it is possible for two keywords to resolve to the same bit, which reduces the accuracy of the redundancy detection. Keyword bit determination algorithms that statistically spread the bit values uniformly may produce better redundancy checks in some embodiments.

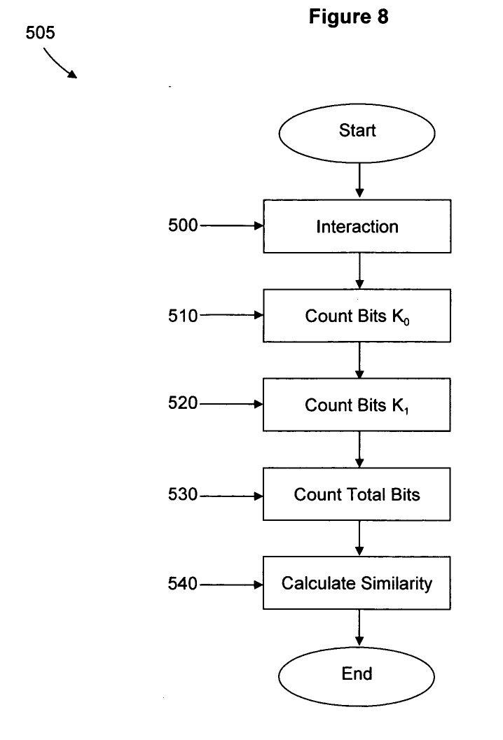

In some embodiments, comparing two articles for similarity may be accomplished in accordance with the invention through method 505 depicted in FIG. 8. Given two articles A₀ and A₁, and their respective keyword bitmasks K₀ and K₁, (which in some embodiments are calculated using the method applying the hash key algorithm described as to FIG. 7), the embodiment of method 505 illustrated includes iterating (step 500), for example, over each bit in the bit mask. Then this particular method 505 includes counting (step 510) the bits K₀, for instance, the total number of bits that have been set to 1 in K₀ (count₀). The embodiment show also includes counting (step 520) bits K₁, for example, the total number of bits that have been set to 1 in K₁(count₁). Method 505 may also include counting (step 530) the total number of bits, which may be at a particular bit index set in each of K₀ and K₁ (matchCount). In certain embodiments, method 505 may also include calculating (step 540) the similarity, for instance, wherein the similarity=matchCount/max(count₀, count₁). This particular similarity metric is higher between two articles that are very similar, and lower between two articles that are less similar.

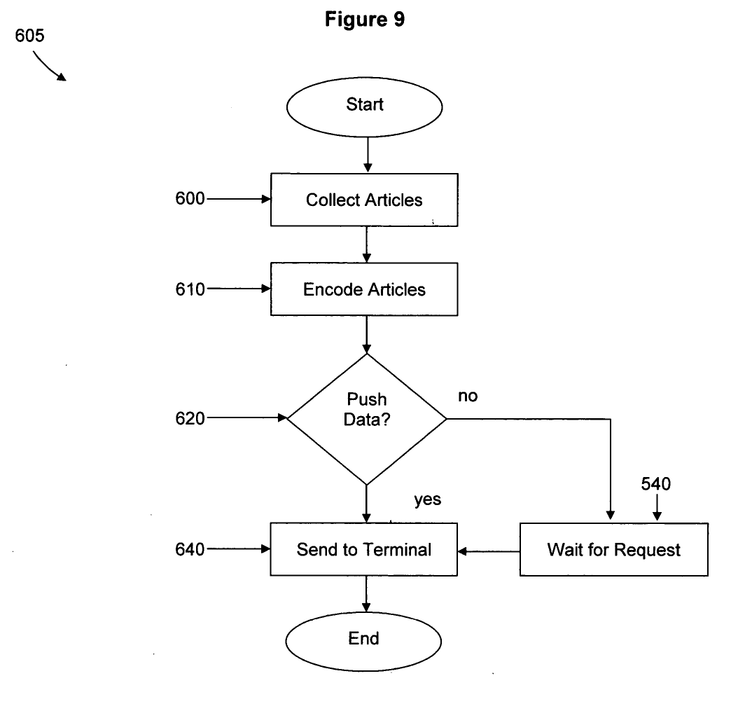

The invention further contemplates assembling news articles and submitting them in one transaction or compilation, for example, as a news communication, to users using, for instance, method 605 illustrated in FIG. 9. As news articles are selected, for instance, from various news feeds 11 or from a customized news channel, and filtered, for example, using the filtering methods and redundancy checking methods described herein, the articles may be placed in a collection of articles (step 600), for instance, to be transmitted to a mobile terminal 16 for viewing by a user. These news articles may contain some or all of the information that would be included with a regular RSS/Atom article, and may also have other information attached, such as the source channel (which is an optional field of an RSS channel description, for example). In many embodiments, the source channel may be included so the article can be associated with its source news channel. For news articles that originate from a customized news channel, an additional field may be added to indicate the channel it originated from.

In some embodiments, the articles are encoded (step 610), such as in an efficient binary representation, or in XML, which may be in a single transaction file. In particular embodiments, it is determined (step 620) whether push data delivery is warranted or whether the delivery of the news article should await a request from mobile terminal 16. For systems supporting push-data delivery, the news article transaction may be immediately sent (step 640), for example, to mobile terminal 16. For systems not supporting push-data delivery, the news article transaction may be cached, waiting (step 630) for mobile terminal 16 to request relevant news content. In some embodiments, whether push-date delivery is supported or not, a mobile device, such as mobile terminal 16, receives a news communication with an encoding of the news article(s), decodes it and presents it to the user.

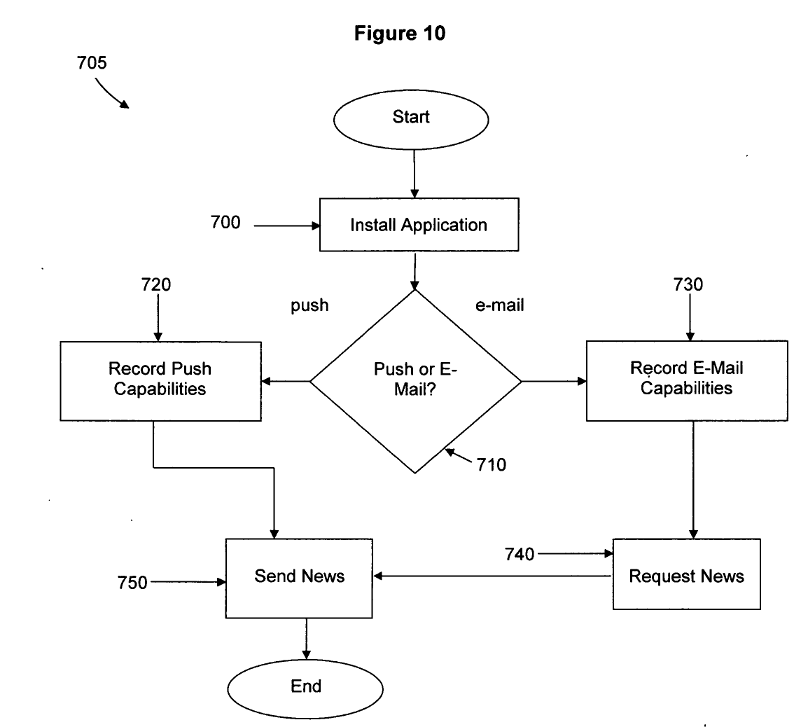

Some mobile terminal systems support a data-push mechanism whereby mobile terminal 16 does not need to request data in order to receive it. Other mobile terminals 16 may not have this data-push mechanism. The system of one embodiment of the invention can detect whether a mobile terminal 16 supports data-push delivery using method 705, illustrated in FIG. 10. In the embodiment illustrated, a compatible news reading application is installed (step 700), for example, on mobile terminal 16. In some embodiments, when executed for the first time, the application sends a message across the wireless network to news processing server 12, in some embodiments to the registration/subscription manager 26, to determine if mobile terminal 16 is configured to support data-push. If the mobile terminal supports data-push (step 710), this information may be recorded (step 720), for example, in the user database 37. In many embodiments, subsequent news updates then have the ability to use this mechanism to transmit the actual news article transaction to the mobile application (step 759). If mobile terminal 16 supports email (step 710), this may be recorded (step 730), for example, in the User Database 37. Thus, subsequent news updates may have the ability to use email to notify the user that news is available on the server. In many embodiments, the user can then use the news reader application to request (step 740) that the available news be sent (step 750) to the device, such as mobile terminal 16. Other notification mechanisms which may be used include SMS, EMS and MMS mobile messaging methods. With some embodiments the mobile application may automatically detect the notification and request (step 740) the new news information without requiring manual intervention from the user. If mobile terminal 16 does not support data-push or any messaging methods, the user may be responsible for manually updating news content on a periodic basis. The application may also be configured, in these cases, to poll periodically to see if a new news transaction is available on the server.

Although the present invention has been described in detail with respect to certain embodiments and examples, variations and modifications exist which are within the scope of the present invention as defined in the following claims.

I claim:

1. A method of delivering news content from at least one of a plurality of news feeds to a pre-determined node, the method comprising in any order at least the steps of:
a. receiving to a news communication subscription system a plurality of news articles, each news article comprising digitally encoded news content, from at least one news feed;
b. selecting and storing at least one of the news articles according to pre-determined system selection criteria;
c. analyzing the news content of the at least one news article according to at least one acquisition metric associated with the pre-determined node, wherein the analysis of news content determines whether the news article meets a pre-determined threshold;
d. preparing a news communication comprising the at least one news article; and
e. sending the news communication to the pre-determined node for display of the at least one news article to a user on a graphical user interface associated with the pre-determined node.

2. The method of claim 1, further comprising the step of revising the acquisition metric associated with the pre-determined node based on the news content of news articles present in the news communication sent.

3. The method of claim 2, wherein the acquisition metric comprises redundancy values.

4. The method of claim 2, wherein the acquisition metric comprises keyword relevancy values.

5. The method of claim 1, wherein the acquisition metric comprises redundancy values.

6. The method of claim 1, wherein the acquisition metric comprises keyword relevancy values.

7. The method of claim 1, wherein the at least one news article is from a first news feed and the news communication comprises a second news article selected and stored from a second news feed in addition to the at least one news article.

8. The method of claim 7, wherein the news communication comprises a third news article selected and stored from a third news feed in addition to the second and first news articles.

9. The method of claim 1, wherein the step of receiving to a news communication subscription system a plurality of news articles further comprises receiving the news articles at substantially asynchronous time intervals.

10. The method of claim 1, wherein the step of selecting and storing a news article further comprises assigning a content metric to the news article.

11. The method of claim 10, wherein the content metric is a bit hash key derived from analysis of textual data in the news article.

12. The method of claim 11, wherein the textual data is analyzed to locate and remove pre-determined words before deriving the bit hash key.

13. The method of claim 1, wherein the acquisition metric is set by the user and detected at the pre-determined node.

14. The method of claim 13, wherein the acquisition metric is based on keywords supplied by the user.

15. The method of claim 13, wherein the acquisition metric is a content filter.

16. The method of claim 15, wherein the acquisition metric is an active subscription account.

17. The method of claim 15, wherein the filter determines matching keywords in at least one news article.

18. The method of claim 15, wherein the filter determines redundancy between news articles in one or more news communications received at the node.

19. The method of claim 15, wherein the step of selecting and storing a news article further comprises assigning a content metric to the news article and redundancy is determined by comparing content metrics of a plurality of news articles.

20. The method of claim 19, wherein the content metric is a bit hash key derived from analysis of textual data in the news article and redundancy is determined by comparing bit hash keys of a plurality of news articles.

21. A news processing server in a news content delivery system, the system in communication with a plurality of news feeds, the server comprising:
a) a news channel parser to read the news feeds for available news articles.
b) a news article analyzer in communication with the news channel parser to analyze the news articles and to assign to each news article a content metric;
c) a news channel database in communication with the news article analyzer to store news articles according to the content metric of the news article; and,
d) a news channel processor in communication with the news channel database to assemble stored news articles into a customized news channel, wherein the customized news channel assembles news articles based on comparison of acquisition metrics associated with a pre-determined node to the news article content metric, for delivery to a user at the node.

22. The server of claim 21, further comprising a news channel updater in communication with the news channel processor, wherein the news channel updater is configured to notify the news channel processor when updated news channel information is available for processing.

23. The server of claim 21 further comprising a subscription manger in communication with the news processing server and a local node for communicating user preferences from the local node to the news processing server, wherein the user preferences comprise at least a portion of the pre-determined news article selection criteria.

24. The server of claim 23 further comprising a user database in communication with the channel processor to store user preferences.

25. The server of claim 21 further comprising a news article push module in communication with the channel processor.

26. The server of claim 21 further comprising a news article notification module in communication with the channel processor and a local node, wherein the news article notification module is configured to notify the local node when new news articles are assembled in the customized news channel.

27. A system for news article delivery comprising;
a) a server in communication with a plurality of news feeds wherein the server is configured to receive news feeds over a communication network;
b) a news channel parser in communication with the server and configured to read the news feeds for available news articles;
c) a news article analyzer in communication with the news channel parser and configured to analyze the news articles and to assign to each news article a content metric;
d) a news channel database in communication with the news article analyzer and configured to store news, articles according to their content metric;
e) a news channel processor in communication with the news channel database and configured to assemble stored news articles into a customized news channel, wherein the customized news channel assembly of news articles is based on a comparison of acquisition metrics associated with a pre-determined node to the news article content metric, for delivery to a user at the local node; and
f) a news article push module in communication with the news channel processor and configured to deliver the news channel to the local node.
